(19) United States
(12) Patent Application Publication
(10) Pub. No.: US 2009/0194891 A1
(43) Pub. Date: Aug. 6, 2009

(54) Long period gratings on hollow-core fibers

(75) Inventors: Wei Jin, Kowloon (HK); Yiping Wang, Kowloon (HK)

Correspondence Address: Wei Jin, The Hong Kong Polytechnic University, Hung Hom, Kowloon, HK

(73) Assignee: The Hong Kong Polytechnic University

(21) Appl. No.: 12/068,371

(22) Filed: Feb. 6, 2008

(51) Int. Cl. B29D 11/00

(52) U.S. Cl. 264/1.27

(57) ABSTRACT

High-quality long periodic grating (LPGs) were written in air-core photonic bandgap fibers by use of high frequency short duration CO2 laser pulses to periodically vary the size and shape of the air-holes in the holey cladding. The variation of cladding holes changes the waveguide structure, instead of the index of the materials forming the waveguide, and resonantly couples the core mode to discrete higher order or surface-like modes and then to lossy quasi-continuum of cladding and radiating modes. This mechanism is different from LPGs in solid core fibers in which the core mode is directly coupled into discrete cladding modes. The LPGs in hollow-core PBFs have unique properties such as very large PDL, very small or insensitivity to temperature, bent and external refractive index, and large strain sensitivity, and will have applications in both communication devices and sensors.

### BACKGROUND

Photonic crystal fibers (PCFs) refer to a class of optical fibers that have wavelength-scale morphological microstructure running down their length. They, according to their guiding mechanisms, may be divided into index-guiding PCFs and Photonic bandgap filters (PBFs). In an index guiding PCF, light is confined to a solid core by modified total internal reflection (M-TIR) from a reduced-effective index cladding material formed by having an array of air-holes within the glass (silica) matrix. In a PBF, light can be confined to a low-index core by reflection from the photonic crystal cladding. Light with propagation constant corresponding to the cladding bandgaps cannot escape the core and is therefore guided along the fiber with low loss.

The most remarkable progress in the development of PBFs may be the guidance of light in an air-core. Since the first demonstration of light guiding in an air-core PBF, tremendous progress has been made in the understanding, design, and fabrication of such fibers.

Practical PBFs with loss as low as 1.2 dB/km have been reported. The guiding of light in air has a number of advantages such as lower Rayleigh scattering, reduced nonlinearity, increased damaging threshold, novel dispersion characteristics, and potentially lower loss compared to conventional optical fibers. These properties are likely to have a lasting effect on optical signal transmission, high power laser pulse delivery and shaping, etc. The hollow-core characteristic of the PBFs also allow strong light/material interaction inside the fiber-core over an extended length, which offers a new platform for developing ultra-sensitive and distributed gas and liquid sensors and for studying nonlinear optics for gases. To increase the impact of the technology, in-fiber components such as wavelength/polarization selective filters are required for manipulating light of different wavelengths/polarizations. Such components have been well developed for conventional glass fiber technology but are not yet available in the format of hollow-core PBFs.

A long period gratings (LPG) is typically formed by periodic perturbation of refractive index along the longitudinal direction of an optical fiber. The period (A) of perturbation is typically within the range from 100 μm to 1 mm. Such an LPG generates mode coupling between a core mode and a cladding mode at a resonant or phase matching wavelength (λᵣₑₛ) given by [11]:

λ_{res,m}=(n_{co}−n_{clad,m})λ (1)

where n_{co} and n_{clad,m} are respectively the indexes of the core-mode and the m^{th} order cladding mode. nc_{co} and n_{clad,m} are functions of wavelength. Usually there are a plurality of cladding modes and Eq. (1) is satisfied at a plurality of wavelengths. The wavelengths satisfying Eq. (1) are typically discrete and separated from each other by tens to hundreds of nanometers. When light propagating in a core mode interacts with the LPG, those wavelengths satisfying (1) are coupled to cladding modes and lost. Hence LPGs can be used as spectral notch filters which selectively attenuate a wavelength of a core mode that satisfies Eq. (1). For a particular fiber, the filter wavelength may be designed by selecting period A and the mode order m. LPGs can also be used as sensors because n_{co}, n_{clad,m} and λ can be sensitive to various environmental parameters such as strain and temperature. In particular, n_{clad,m} is typically sensitive to external refractive index variation near the surface of the fiber and can then be used to sense such a parameter.

LPGs have been made in conventional optical fibers, index-guiding photonic crystal fibers (ID PCFs) as well as solid-core PBFs made by filling high index fluid into the holes of an ID PCF. The principal mechanisms for the formation of such LPGs are refractive index variation of core (sometimes also cladding) material through UV photo-sensitivity, external applied stress, residual stress-relaxation and glass structural change. However, so far no report on LPGs in air-core PBFs, probably due to the difficulty in introducing refractive index modulation into air-holes in which over 95% light energy of the fundamental mode is located. To inscribe an LPG in such a hollow-core fiber, a mechanism different from the refractive index perturbation of the material is required, and the properties of such made gratings can also be different from the LPGs in solid-core index-guiding optical fibers.

It is therefore the aim of this invention to provide a mechanism to form a type of LPGs in hollow-core fibers and a method for fabricating such LPGs and examine the potential applications of such LPGs.

### SUMMARY

The present invention relates to a LPG that can be made by periodically varying the shape, size and distribution of air-holes along a hollow-core PBF. The periodic perturbation of the fiber cross-sectional geometry resonantly couples the fundamental core mode to intermediate higher order or surface-like modes and further to the quasi-continuum lossy cladding and radiation modes and results in a notch in the transmitted spectrum.

According to an embodiment of the invention, a mechanism for forming an LPG in a hollow (air or vacuum) core PBF is provided where the waveguide geometric structure is perturbed by periodically varying the size, shape, and distribution of air-holes along the longitudinal direction of the hollow-core PBF. This mechanism is different from LPGs in solid-core fibers where the main perturbation is the material refractive index of the core. The perturbations in the size, shape, and distribution of holes are mainly in the cladding region with no change or very little change in the center hollow-core. The perturbation can be circularly symmetric in the change of hole size and shape occurs symmetrically around the centre core, or asymmetric where one or more regions of air-holes in the cross-section are perturbed.

According to another embodiment of the invention, a mechanism for generating resonant coupling between core and cladding or radiation modes in a hollow (air or vacuum) core PBF is provided. This mechanism is different from that in conventional solid-core fibers in that the hollow-core PBG fiber the core mode is coupled into higher order or surface-like modes and further into extended lossy quasi-continuum cladding or radiation modes, while in the conventional solid-core fibers a core mode is directly coupled into discrete cladding modes. The higher-order or surface-like modes are discrete and have considerable overlap with the fundamental core mode and the periodic perturbation facilitates the phase-matching and hence resonant coupling between them.

In still yet another embodiment of the invention, a method for fabricating an LPG in hollow (air or vacuum) core PBF is provided. The method is based on the use of a pulsed CO₂ laser to scan transversely across the fiber. The laser beam is focused to a spot with size from 10 μm to 100 μm in diameter, and the pulse width, repetition rate and average power are selected respectively to within the range from 1 μs to 20 μs, 1 kHz to 50 kHz, and 0.1 to 1 W, and the exact values of these parameters are selected in a coordinated manner to heat locally a short section but not other section of the fiber. For each transverse scan, only a short section of fiber from about 20 μm to 200 μm along the longitudinal direction of the fiber is significantly affected by the heat which causes ablation of glass on the surface and change of shape and size, and even complete collapse of some of the air holes in the cladding in the heated section. This results in a notch or a groove transverse to the longitudinal direction of the fiber. An integer number (N) of grooves may be made by scanning transversely across the fiber N times with adjacent scans separated by a grating period λ. The depth of the grooves can also be increased by repeatedly scan through the N-grooves M times (or called M cycles) with M ranging from 1 to 100. The general rule is that fabrication parameters including pulse width, peak power, repetition rate, and the number of scanning cycles (M) should be chosen in such a combination that no significant deformation in the hollow-core is taking place but partial collapse or deformation of the cladding holes on one or more side of the cross-section occurs. The outer rings of air-holes are largely deformed or even completely collapsed but the holes near the core are only deformed slightly or have no deformation. This ensures that light at the resonant or phase matching wavelength coupled to the higher-order or surface-like mode and further to the extended mode and lost, while light at other wavelength remain in the fundamental core mode with minimal loss.

The transmission spectrum of an LPG in the hollow-core PBF fabricated according to the above procedure can have one or more notches (transmission dips or rejection bands), with each of them corresponds to a different higher order or surface-like modes. The center wavelength can be designed by selecting the grating pitch A and the order of the surface-like modes. The notch depth can be controlled by adjusting fabrication parameters, e.g., by controlling the number of the repeated scanning cycles M.

The center wavelength of the above notch filter has very small sensitivity or is insensitive to temperature, bend and external refractive index, and can then be used as stable wavelength filters. Multiple-notch comb-filters may be realized by writing multiple LPGs along the same PBF.

The sensitivity of such a notch filter to strain is about three times higher than that of LPGs in conventional single mode fibers (SMFs), indicating that our LPG may be used as a strain sensor with very small or almost no cross-sensitivity to temperature, bend, and external refractive index.

The CO₂-laser-based fabrication technique results in significant asymmetry in waveguide cross-section due to the collapse or deformation of the air holes on one side of the hollow-core PBF. This induces large birefringence and asymmetrical mode field distribution in the fiber cross-section and results in polarization dependent loss of as high as high as 25 dB near the resonant wavelength.

### BRIEF DESCRIPTION OF THE DRAWINGS

The invention will now be described, by example only, with reference to the following figures:

FIG. 1(a) shows the scanning electron micrograph (SEM) of original PBF cross-section;

FIG. 1(b) shows the SEM cross-section of PBF after one side of the hollow-core PBF is treated by pulsed CO₂ laser radiation;

FIG. 1(c) shows the side-view of PBF with the notched parts indicating the CO₂ laser treated sections;

FIG. 2 is the method of making the present hollow fiber with long period gratings;

FIG. 3 shows the transmitted spectrum of the present long period grating fiber;

FIG. 4 shows the mode intensity patterns observed at different locations (a) just before the first notch, (b) at the 6^{th} notch, and (c) at the 19^{th} notch) along the LPG at the resonant wavelength (1523.1 nm), and (d) at a wavelength away from the resonant wavelength (at the 19^{th} notch at 1540 nm);

FIG. 5(a) shows the variation of the resonant wavelength with grating pitch;

FIG. 5(b) shows the transmitted spectrums for different grating pitch;

FIG. 6(a) shows the polarization dependent loss near the resonant wavelength (1595.8 nm) of a LPG on hollow-core PBF with 20 periods and a grating pitch of 395 μm;

FIG. 6(b) shows the measured resonant wavelength and attenuation at the resonant wavelength as function of temperature for a LPG on hollow-core PBF with 20 periods and a grating pitch of 395 μm μm;

FIG. 6(c) shows the measured resonant wavelength and attenuation at the resonant wavelength as function of curvature for a LPG on hollow-core PBF with 20 periods and a grating pitch of 395 μm μm;

FIG. 6(d) shows the measured resonant wavelength and attenuation at the resonant wavelength as function of strain for a LPG on hollow-core PBF with 20 periods and a grating pitch of 395 μm.

### DESCRIPTION

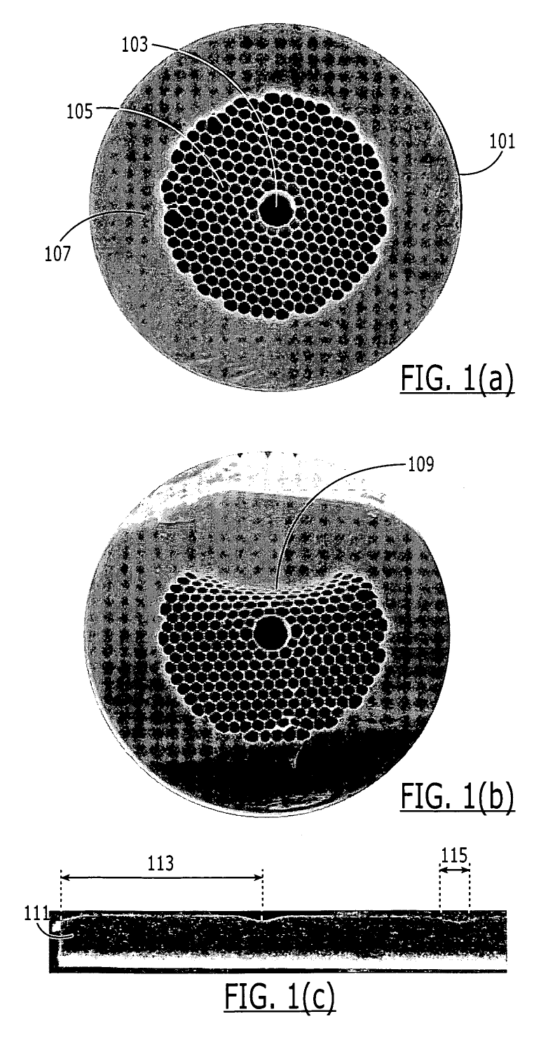

In the following, the embodiments of the LPG on hollow-core PBF according to the present invention are explained with reference to FIGS. 1 to 6.

FIG. 1A shows the cross-section of a typical air/silica hollow-core PBF 101. The PBF 101 consists of an air core 103, a holey air/silica inner cladding 105 with an air-filling fraction of larger than 80%, and preferably larger than 95%, and on outer silica cladding 107 in the hollow-core PBF; light is confined to the center air-core 103 by reflection from the photonic crystal cladding 105. Light with propagation constant within the cladding bandgaps cannot escape the core 103, and is therefore guided along the fiber 101 with low loss. Transmission bands or windows of the air/silica hollow-core PBF is determined by the spacing between the holes and the hole diameter or air-filing fraction. For the present PBF 101, the major transmission window is from 1500 nm to 1700 nm. The transmission loss within the window is typically below 28 dB/km.

As shown in FIG. 1(b), the holes in the cladding of the fiber can be deformed periodically along the fiber by local heating. Deformation can be introduced by use of a pulsed CO₂. In this embodiment, the deformation of air holes is one side of the fiber cladding. A pulsed CO₂ laser is used to locally heat the fiber from one side. Other cross-sectioned deformation patterns such as deformation on the two opposite sides of the fiber, or circularly symmetric deformation of air-holes in the cross=section may be achieved by using other heating sources to create an LPG.

The use of the CO₂ laser results in notches being created on the surface of the fiber. The laser beam is moved longitudinally along the fiber by a grating period mu and the same process is repeated to produce the 2^{nd}, 3^{rd}, N^{th} notches. An LPG with N notches is then produced. This process of making N notches is called a scanning cycle. The notch depth can be increased by having more scanning cycles. As a result, periodic notches with required depths are created along the fiber surface.

FIG. 1(c) shows the notches made on a PBF. The width of each notch 115 can be from about 50 nm to about 70 nm, and the distance 113 between each notch can be between 300 μm to about 500 μm.

Periodic perturbations along the axis of fiber are required to achieve resonant mode coupling in an LPG. For the present LPG, the required periodic perturbations could be due to two factors: the stress relaxation induced refractive index perturbation of glass material and the changes in air-hole size and shape that perturb the waveguide (geometric) structure. Residual stress exists in glass after a perform comprising of stacked capillaries was drawn to a PBF. The irradiation of CO₂ laser beam on the fiber induces local high temperature and relaxes the residual stress around the notched region, resulting in refractive index perturbation of glass due to the photo elastic effect. However, as most light power of the fundamental mode (>95%) is in the air region, the effect of stress relaxation on the mode index is much smaller than that for conventional fibers and solid core PCFs. On the other hand, the collapse of air-holes in the cladding results in a change in the shape and size of air-holes as shown in FIG. 1b, this changes the air-filling fraction and the waveguide guide structure and perturbs the mode fields and effective index of the core, surface and cladding modes. There could also be weak deformation of the hollow-core, although it is not observable in our experiments. We believe that the periodic perturbation of the waveguide (geometric) structure is the main mechanism for resonant mode coupling, although the stress relaxation-induced index variation could also contribute a little.

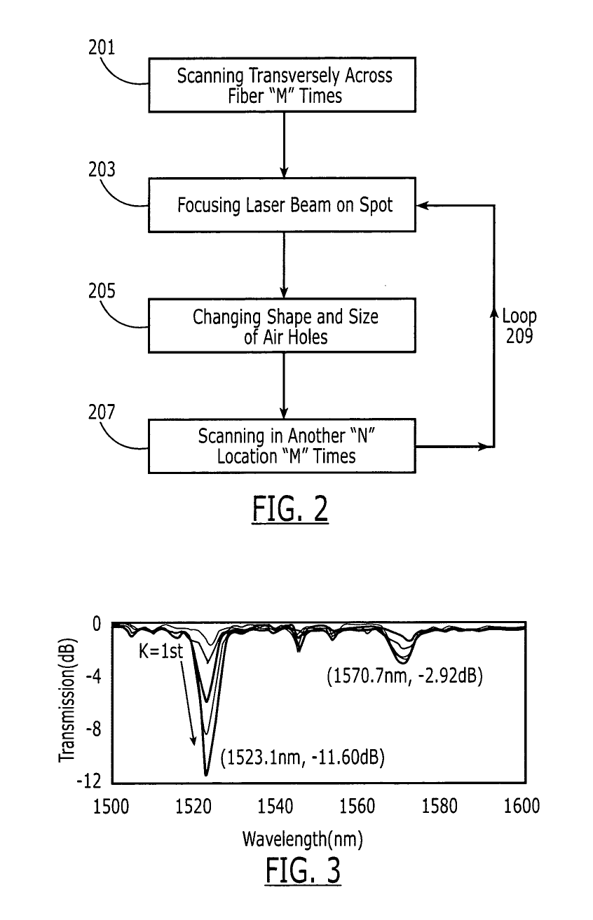

FIG. 2 shows the method of producing long periodic gratings in hollow-core fibers of the present inventions CO₂ laser pulses are utilized to create the LPG.

In the first steps, CO₂ laser pulses scan transversely across a hollow-core PBF for “M” number of time 201. The focus of the laser beam 203 induces a local high temperature, causing ablation of glass on the surface, and change the shape and size, and even collapse, some of the air holes in the cladding 205. Another location along the PBF, at an “N” distance away, is then chosen for scanning. As stated, scanning then proceeds 207, the notches are from about 50 μm to about 70 μm in diameter, and about 300 μm to 500 μm in distance. The process is then repeated, or looped multiple times 209 until the desired number of notches are obtained.

### EXAMPLE

A hollow-core PBF having long periodic gratings was created in accordance with the present invention.

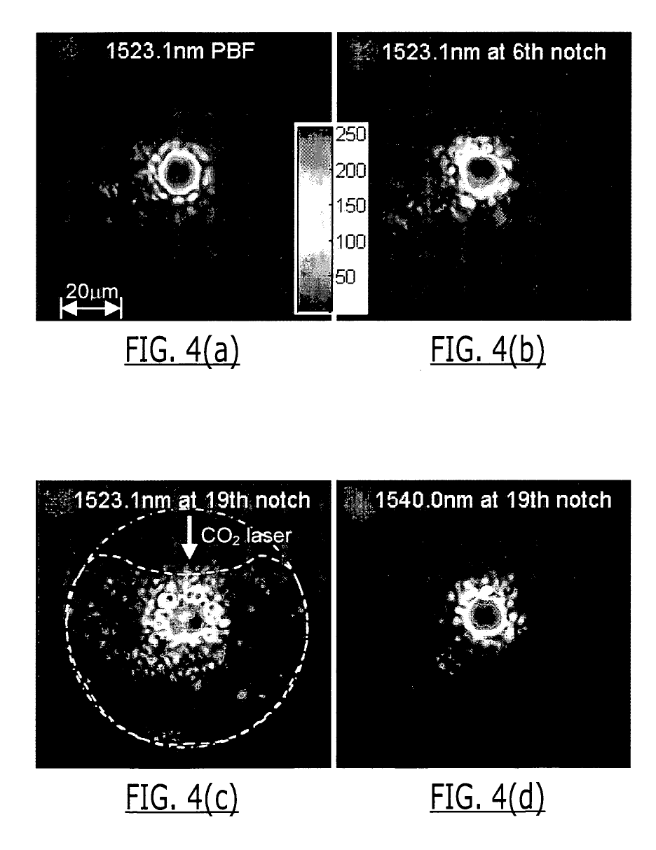

The observed resonance in FIG. 3 may be considered to be originated from a two-step process: light meeting the phase matching condition is coupled from the core made to higher-order or surface-like modes due to the spatial overlap of these modes at the perturbed region, and then to quasi continuum of extended modes, e.g. cladding and radiation modes, and lost.

FIG. 3 shows the measured transmitted spectrum of a 40-period LPG with a grating period of 430 μm made by the above process. Two main attenuation dips are observed within the wavelength range between 1500 nm and 1620 nm. The 3 dB-bandwidth is ˜5.6 nm, much narrower than that of the LPGs in a conventional single mode fiber (SMF) with same number of grating periods. The insertion loss of the LPG is very low and less than 0.3 dB, because most light is guided in the hollow-core where no deformation was observed. A proper choice of the fabrication parameters is critical for the fabrication of a high-quality LPG in the air-core PBF. High energy pulses with a long irradiation time causes large deformation or collapsing of the holes and thus a higher insertion loss, while low energy pulses with short irradiation time is insufficient to inscribe an LPG on the PBF. We have also fabricated LPGs with a smaller number of grating period (e.g. 20) and found that the 3 dB-bandwidth becomes larger for a smaller number of grating periods.

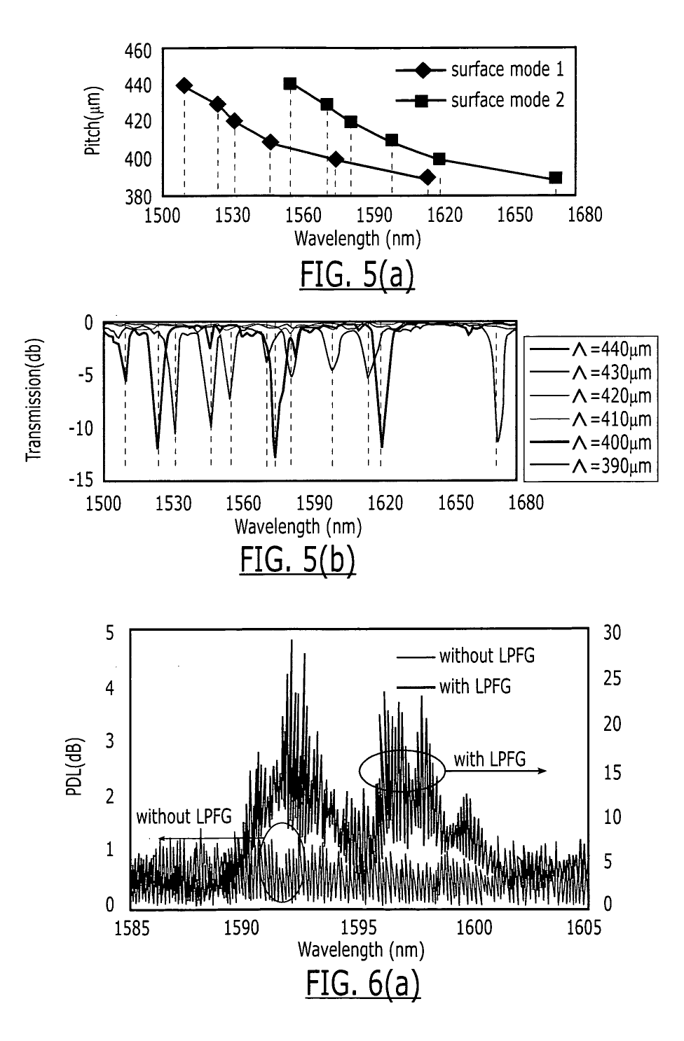

A single wavelength tunable laser (Agilent 81600B) was used as the light source to illuminate the PBF via a lead-in SMF-28 fiber pigtail and some of the recorded images are shown in FIG. 4. Away from the resonance at 1540.0 nm, light power is mainly in the fundamental mode within the hollow-core and no clear cladding mode was observed ((d) in FIG. 4). Near the resonance at 1523.1 nm, before the LPG, the light intensity is mainly in the fundamental mode (a). With an increase in the number of grating pitches, light energies in the higher order or surface-like modes and cladding modes are enhanced whereas that in the fundamental mode is reduced, as can be seen from (b) and (c) in FIG. 4. At the 19^{th} notch, most energy in the fundamental mode is coupled out so that the surface-like and the cladding modes were clearly observed and light intensity at the center of hollow core becomes very weak (see (c)). Light coupled into the cladding mode is limited within the holey cladding region as outlined by the dot-dashed curve, and the energy of the surface-like mode in the side facing to CO₂ laser irradiation is stronger than that in the opposite side. The near field image with weak intensity at the core center is believed to be the second order core modes (TE₀₁, TM₀₁, and HE₂₁), these modes can not be seen at the present of strong fundamental mode, but become easier to observe with the reduction of fundamental mode intensity.

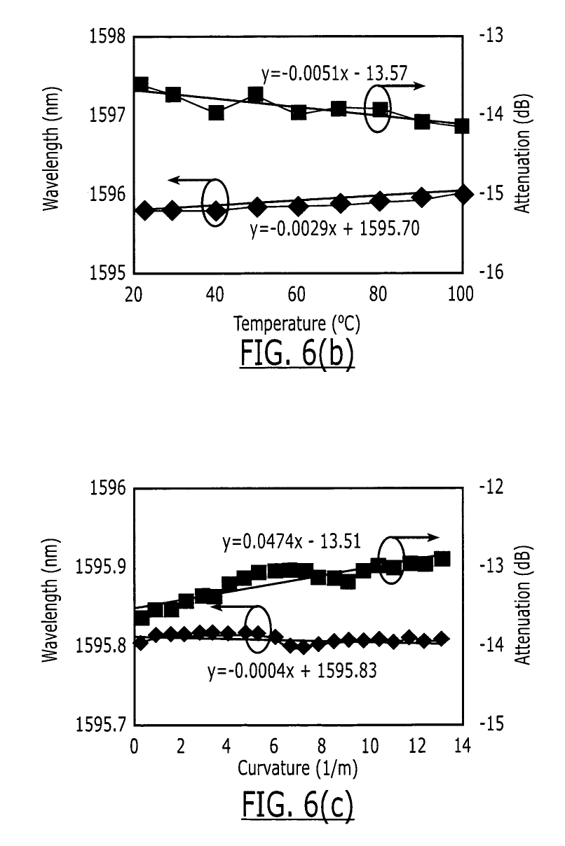

To investigate the phase matching condition as function of wavelength, six LPGs with different pitches and the same number of grating periods were written in the PBF. The measured resonant wavelength as functions of the grating pitch are shown in FIG. 5(a), the resonant wavelength decreases with the increase in grating pitch, which is opposite to the LPGs in the conventional SMFs. For each of the LPGs, two main attenuation pits, as shown in FIG. 5(b), were observed within 1500 nm to 1680 nm, indicating that the fundamental mode is coupled to two different surface modes.

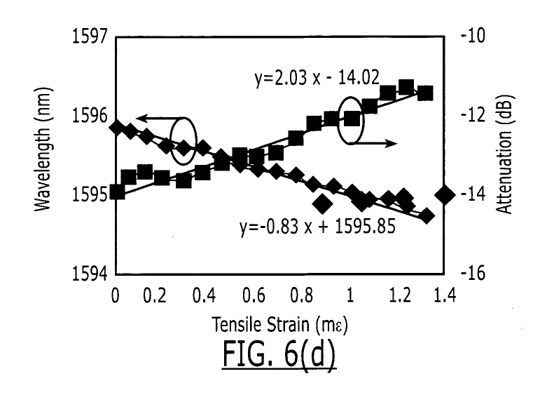

The responses of the LPG in the air-core PBF to strain, temperature, bend and external refractive index are also investigated. The temperature sensitivity of the resonant wavelength and the peak transmission attenuation are respectively ˜2.9 pm/° C. and −0.0051 dB/° C. (FIG. 6(b)), which is one to two order of magnitude less than those of the LPGs in the conventional SMFs. When the curvature of LPG is increased to 13.3 m⁻¹, the resonant wavelength and the peak transmission attenuation changed by only ±8 pm and 0.71 dB (FIG. 6(c)), respectively, which is three to four order of magnitude less than those of the LPGs in the conventional SMFs. In addition, when the LPG in the PGF was immerged into the refractive index liquids (from Cargill Labs) with indexes of 1.40, 1.45 and 1.50, respectively, the resonant wavelength and peak transmission attenuation hardly changed, whereas the LPGs in the conventional SMFs are very sensitive to external refractive index, especially when the index is about 1.45. These stable optical features are advantage to their applications in the optical fiber sensors and communications devices. With the increase of applied tensile strain, the resonant wavelength of our LPG shifts linearly toward shorter wavelength with a strain sensitivity of −0.83 nm/mε and the peak transmission attenuation is decreased with a sensitivity of 2.03 dB/mε. The sensitivity of the resonant wavelength to strain is two or more times higher than that of LPGs in conventional SMFs, indicating that our LPG may be used as a strain sensor without cross-sensitivity to temperature, curvature, and external refractive index.

1-7. (canceled)

8. A method of forming a long period grating on a hollow-core photonic bandgap fiber, the method comprising:
using a CO₂ laser beam to periodically change shape and size of air holes in cladding of the hollow-core photonic bandgap fiber, or collapse the air holes in the cladding.

9. The method according to claim 8, wherein the CO₂ laser beam is a focused laser beam.

10. The method according to claim 9, wherein the focused laser beam occurs at a spot having 20 μm to 100 μm in diameter.

11. The method according to claim 8, wherein the CO₂ laser beam is a pulsed laser beam with a pulse width between 1 μs to 20 μs, a repetition rate between 1 kHz to 50 kHz, and an average power between 0.1 W to 1 W.

12. The method according to claim 8, wherein the laser beam scans transversely across the hollow-core photonic bandgap fiber for “M” times at one location.

13. The method according to claim 12, wherein “M” is a number between 1 to 100.

14. The method according to claim 12, wherein the transverse scanning creates a notch on a surface of the hollow-core photonic bandgap fiber

15. The method according to claim 14, wherein the notch is between 2O μm to 200 μm in width, and between 5 μm to 4 μm in depth.

16. The method according to claim 12, wherein the transverse scanning is repeated at another “N-1” locations longitudinally along the hollow-core photonic bandgap fiber.

17. The method according to claim 16, wherein “N” is a number between 5 to 100.

18. The method according to claim 16, wherein the longitudinal spacing (grating period or grating pitch) between two adjacent transverse scans is from 100 μm to 1000 μm apart in distance.

19. The method according to claim 16, wherein the transverse scanning is repeated at the “N” locations.
